(19) United States
(12) Patent Application Publication
(10) Pub. No.: US 2022/0329552 A1
(43) Pub. Date: Oct. 13, 2022

(54) Internet Based Remembrance and Delivery Organization and Facilitation System

(71) Applicant: Michael Anzalone, Berne, NY (US)

(72) Inventor: Michael Anzalone, Berne, NY (US)

(21) Appl. No.: 17/716,812

(22) Filed: Apr. 8, 2022

Related U.S. Application Data
(60) Provisional application No. 63/172,921, filed on Apr. 9, 2021.

(51) Int. Cl. H04L 51/10

(52) U.S. Cl. CPC H04L 51/10; H04L 51/56

(57) ABSTRACT

The disclosed invention deals with various configurations of unique Internet-based software creating a remembrance facilitation system. To wit, a system that stores before death experiences that will be sent via email, text message, video, multimedia, audio, and other media delivery systems to one or more recipients after the death of the originating agent on certain conditions, according to time and activities performed by the recipient(s).

### CROSS-REFERENCE TO RELATED APPLICATIONS

This non-provisional application claims benefit of U.S. Prov. App. No. 63/172,971 filed on Apr. 9, 2021, and incorporates that application, in its entirety, by reference.

### FIELD OF THE INVENTION

The present disclosure deals with various configurations of unique Internet-based software implementing a remembrance facilitation system. To wit, a system that stores before death experiences that will be sent via email, text message, video, multimedia, audio, and other media delivery systems to be delivered to one or more recipients after the death of the originating agent on certain conditions, according to time and activities performed by the recipient(s).

### BACKGROUND OF THE INVENTION

Internet systems that electronically store and send messages created by an individual after the death of that individual have been in existence for many years. Time-based systems that deliver stored messages at a particular time, or on a particular date, created by an individual after the death of that individual have also been in existence for many years. Many other variants delivering messages from an individual after the death of that individual have also been in existence for many years.

These systems have not been commercially successful, however. Therefore, the present application discloses certain improvements to existing systems that improve commercial prospects of these systems.

### BRIEF SUMMARY OF THE INVENTION

The software is a single user password protected data storage organizational program which simultaneously works on personal computers, tablet computers, and smart phones which access the device's camera, photo, data libraries, and microphones through proprietary software to upload the originating agent's (user's) data before the death of the originating agent for future release on agent determined dates and trigger (caretaker) created dates before and after the death of the originating agent following the death of the originating agent. Also, the system delivers messages in conjunction with publicly triggered events, such as purchasing a house, purchasing an automobile, getting married, becoming a member of the armed forces, having a child, etc.

The software implementing the system has the following features: Uploaded files are automatically compressed (reduced in size) for efficient cloud storage through proprietary software. Also, any individual may purchase the services of the system. Notifications of such purchases may be printed or emailed. Also, the system may generate unique redeemable gift codes.

Also, the user selects a single trigger (caretaker) with the sole purpose of initiating data distribution. Messages are sent automatically to trigger feedback following the lack (or absence) of events from the recipient. Messages are sent automatically on the reported death of the originating agent (triggered by an obituary, news article, or other public record). The system also sends messages regarding the state of the system involving the originating agent's transaction regarding the trigger (caretaker).

Also, automatic messages are sent to the trigger (caretaker) to acknowledge their designation or acceptance as a trigger. Also, to ensure that the trigger (caretaker) has received notice that he has been appointed trigger (caretaker), a printed notice may be sent to him. Also, the printed notice may be associated with the originating agent's will to memorialize his appointment. Also, the trigger (caretaker) may have a gift card sent to him or some other payment made to him as an inducement to serve as the trigger (caretaker). Also, the trigger (caretaker) can download or print a document or certificate as a hard copy reminder that they are in fact the trigger (caretaker). Also, the originating agent can print the same document or certificate naming the trigger (caretaker) to be placed with the originating agent's will or other important papers.

Also, the user adds an unlimited number of members (and their images) (which are automatically compressed) as data recipients. Messages are automatically generated and sent to members for their acceptance indicating that they will receive future messages (such messages include audio, video, documents, and pictures).

Also, recipients automatically receive periodic messages prompting them to update and add additional data. Recipients will also receive messages prompting them to set up their own accounts.

Also, the user has the ability to create their own audio and visual biography which (upon their approval) can be automatically shared with genealogical websites, social media, and any other user acceptable media.

Also, the user has ability to create unlimited messages including additional data files to be delivered on specific and trigger (caretaker) designated dates following the triggering of system.

Also, dates for distribution can be delivered as one time, yearly, any future single year, or any user selectable group of future dates.

Also, the user can designate a single, a group, or all members to receive specific data packages.

Also, the user has ability to add unlimited currently unknown members as members. Examples: Unborn children, future family members, etc.

Also, upon triggering of the system, data is released as specified through email, text message, or any future type of media distribution.

Also, the program compiles user's data storage total and initiates auto generated messages when data limits are reached. The originating agent (or his trust) has the ability to pay additional funds to acquire additional storage and/or message transmission capability.

Also, the program tracks usage by user.

Also, the program has the ability to add various system sponsors.

Also, the program has the ability to easily be rebranded as a “white label” or a “private label” system.

Also, the program uses proprietary software to access smart phone's and tablet computer's microphone.

Also, the program uses proprietary software to resize and compress digital photos.

Also, the program uses proprietary software to translate text and the textual elements of non-textual elements (logos, photos) into other languages before storing.

### DETAILED DESCRIPTION OF THE INVENTION

The software is a single user password protected data storage program working on personal computers, tablet computers, and smart phones which access the device's camera, photo, data libraries, and microphones. Using a proprietary software component run prior to the functioning of the system on the web server, information is uploaded from the device's camera, photo, data libraries, and microphones to the web server.

This uploaded information is then designated for delivery to individuals or groups of people on specific dates or on the occurrence of certain events. A caretaker (or trigger) is appointed when the system is setup and works in concert with the web server-based system to ensure that the provided information is delivered or not delivered, depending on the situation.

Also, the user adds an unlimited number of members (and their images) (which are automatically compressed) as data recipients. Messages are automatically generated and sent to members for their acceptance indicating that they will receive future messages (such messages include audio, video, documents, and pictures.)

When operating, the client-based software uploads collected data to a web server. The web server tracks all dates and initiates the delivery of messages on the dates that they are scheduled to be delivered. Also, the web server independently collects data from the Internet regarding information germane to the uploaded collected data. For example, the system delivers messages in conjunction with publicly triggered events, such as purchasing a house (when records of the transaction appear in the public land records), purchasing an automobile (when records regarding the purchase appear in the motor vehicle database), getting married (when the license is taken out at the county records office), having a child (when records regarding the birth are publicly filed with the state), etc. Data provided by genealogical databases such as Ancestry.com and FamilySearch.org may also drive the system.

The software implementing the system has the following features: Uploaded files are automatically compressed (reduced in size) for efficient cloud storage through proprietary software. This allows the extensive storage of transactional data regarding many events. Tokens are used to maximize this compression. For example, that an individual was born may be represented by a one-byte token. As would be that a person died, was married, purchased real estate, paid their local taxes, etc. Also, stored data may be encrypted for additional security.

Also, the originating agent (the user) selects a single trigger (caretaker) with the sole purpose of initiating data distribution. The system will send operational and accounting status messages to the trigger (caretaker). The system will also send messages to the trigger (caretaker) if the trigger (caretaker) is designated as a recipient of messages from the originating agent. Triggers activate the functioning of the system and serve to verify that the originating agent or person has indeed passed away. The system may also send messages automatically to the originating agent after the originating agent sets up the system to determine if the originating agent is still alive. If the originating agent does not respond, then the system may activate and begin the automated transmission of collected messages. Of course, messages are sent automatically on the reported death of the originating agent (triggered by an obituary or news article). Death may be ascertained by an obituary, news article, or other public record. If death is ascertained by an obituary, news article, or other public record it may be verified by the caretaker. Only if death is verified in this case, will messages be sent.

Messages are sent automatically to the trigger (caretaker) to inform and gain their acceptance of their designation as trigger. Triggers (caretakers) need not respond to the automatically sent messages. If they do not, then the system will attempt to verify the death of the originating agent and begin operation automatically. Also, to ensure that the trigger (caretaker) has received notice that he has been appointed trigger (caretaker), one or more printed notices may be sent or mailed to him. Also, the printed notice may be associated with the originating agent's will or a trust to memorialize his appointment. Also, the trigger (caretaker) may have one or more gift cards sent to him or one or more other payments made to him as an inducement to serve as trigger (caretaker). Also, the trigger (caretaker) may download or print a document or certificate as a hard copy reminder that they have, in fact, been appointed as a trigger (caretaker). Also, the originating agent may print the same document or certificate naming the trigger (caretaker). This document or certificate may be given to the originating agent's estate attorney or placed with the will or other important papers.

The originating agent adds an unlimited number of members (and their images and other personal data) (which are automatically compressed and encrypted) as data recipients. Messages are automatically generated and sent to these members for their acceptance indicating that they will receive future messages (such messages include audio, video, documents, and pictures). These messages may be delivered via email, text message, telephone, and any other electronic means.

Recipients automatically receive periodic messages prompting them to update and add additional data. Such data is then mined, and additional responses are generated by the system and sent to the recipients. Recipients may also be targeted with messaging prompting them to setup their own account.

The user has the ability to create their own audio and visual biography which (upon their approval) can be automatically shared with genealogical websites, social media, and any other user acceptable media. For example, an Ancestry.com template may be provided to upload the biography into Ancestry.com's database in Ancestry.com's format.

The originating agent has the ability to create unlimited messages including additional data files to be delivered on specific and trigger (caretaker) designated dates following the activation of the system. The originating agent may create literal messages—which are messages regarding a single or several topics for delivery in a particular instance, and virtual messages—which are messages about certain topics that may, or may not, ever be delivered. An example of a literal message would be a happy birthday wish. An example of a virtual message would be a political statement.

Dates for distribution can be delivered as one time, yearly, any future single year, or any originating agent selectable group of future dates. Any type of event may trigger a message or stream of messages. For example, a declaration of war by the United States may trigger a message or stream of messages.

The originating agent can designate any single individual, group of individuals, or all individuals to receive specific data packages. The originating agent can designate any single individual, group of individuals, or all individuals to not receive specific data packages. The first group may be modified by the second group.

The originating agent has ability to add unlimited currently unknown members as members. For examples, unborn children, future family members (spouses), adoptees, etc. may be added. The system will monitor death notices to determine when a recipient has died. This will terminate message delivery to the deceased member.

Upon triggering of the system, data is released as specified through email, text message, or any future type of electronic media distribution. Of course, a recipient may opt out of the receiving messages. Also, if the agent of a recipient or his estate requests removal, the removal process will begin.

The program compiles the originating agent's data storage total and initiates auto generated messages when data limits are reached. After the death of the originating agent the trigger (caretaker) is notified. Ordinarily, the originating agent prepays or a trust fund is set up to pay the billings accrued by the originating agent. The originating agent and the trust fund may limit payments to any amount and may cease payments at any time. Also, after the death of the originating agent messages may be delivered to the recipients for a fixed period of time free of charge. After the fixed period recipients may be asked to pay a fee. Also, in lieu of paying a fee, recipients may instead set themselves up as a secondary originating agent. By this means they continue to receive messages from the original originating agent free of charge.

The program tracks usage by user (recipient). The program tracks the number of messages sent to each user. The program tracks the tolls associated with sending each message to a user. The system generates reports showing what messages were sent, to whom they were sent, and when they were sent.

The system has the ability to add various system sponsors. Such sponsors may be acknowledged at the corporate level. Such sponsors may be privately designated.

The program has the ability to easily be rebranded as a “white label” or a “private label” system by universal alteration of corporate logos and messages. This allows easily designating a new owner.

The program uses proprietary software to access smart phone's and tablet computer's microphone. Collected audio is stored for later transmission as other information is.

Also, the program uses proprietary software to resize and compress photographs.

Also, the program uses proprietary software to translate text and textual elements of non-textual (graphic) elements such as logos into other languages before storing. This information is also stored for later transmission.

Also, data in the system is encrypted using an individual-based revolving encryption. Only the caretaker (trigger) has the ability to unencrypt the data stored by the originating agent.

Also, the system offers multiple methods of verifying death: Published or publicly accessible data, database derived data, audibly or visually presented notices of death, the input of third parties including the caretaker (trigger) may be used to establish that the originating agent has died.

Also, the system is constructed such that it is self-perpetuating and automatically grows by soliciting and adding new users.

Also, the caretaker or any other family member may begin paying the originating agent's fee if the originating agent is disabled (stroke, coma, etc.)

While the present invention has been described in what are thought to be the most useful and practical embodiments, it will be readily apparent to those having skill in the art that other variations may be readily conceived and created. Accordingly, these and all such other readily conceived and created variations are implicitly included in the spirit and scope of the present disclosure.

What is claimed is:

1. An Internet-based remembrance facilitation system comprising:
a) a pre-death software system operating on a personal computer, a smart phone, or a tablet computer which collects information from an originating agent regarding:
i. what is to be in messages;
ii. to what individuals the messages are to be delivered;
iii. when the messages are to be delivered or under what conditions the messages are to be delivered; and
iv. the means by which the messages are to be delivered;
b) a means of determining the death of the originating agent;
c) a post-death software system which:
i. delivers messages derived from collected information to the selected individual or individuals;
ii. delivers messages when such messages are scheduled or under what conditions the messages are scheduled by the originating agent;
iii. delivers messages by the means selected by the originating agent;
d) wherein the messages are delivered to the selected individual or individuals, on the dates or under the conditions designated, and by the means designated, after the death of the originating agent has been determined.

2. An Internet-based remembrance facilitation system of claim 1 wherein the means of determining the death of the originating agent comprises a trigger (or caretaker) who determines if the originating agent has died.

3. An Internet-based remembrance facilitation system of claim 1 wherein publicly published documents are inspected by the system to determine if the originating agent has died.

4. An Internet-based remembrance facilitation system of claim 1 wherein at least one message may be delivered on a fixed schedule.

5. An Internet-based remembrance facilitation system of claim 1 wherein at least one message may be delivered on a random schedule.

6. An Internet-based remembrance facilitation system of claim 1 wherein at least one message may be delivered when a specific event has occurred.

7. An Internet-based remembrance facilitation system of claim 1 wherein at least one message may be delivered on an annual date.

8. An Internet-based remembrance facilitation system of claim 1 wherein at least one message may be delivered on an anniversary.

9. An Internet-based remembrance facilitation system of claim 1 wherein the means by which messages are delivered is email.

10. An Internet-based remembrance facilitation system of claim 1 wherein the means by which messages are delivered is text messaging.

11. An Internet-based remembrance facilitation system of claim 1 wherein the means by which messages are delivered is voice mail.

12. An Internet-based remembrance facilitation system of claim 1 wherein the means by which messages are delivered is text-to-speech delivered by telephony.

13. An Internet-based remembrance facilitation system of claim 1 wherein the means by which messages are delivered is text-to-speech delivered by voice mail.

14. An Internet-based remembrance facilitation system of claim 1 wherein the means by which messages are delivered is a website.

15. An Internet-based remembrance facilitation system comprising:
a) a pre-death software system which collects information from an originating agent regarding:
i. what is to be in messages;
ii. to what individual or individuals the messages are to be delivered;
iii. when the messages are to be delivered or under what conditions the messages are to be delivered; and
iv. the means by which the messages are to be delivered;
b) a means of determining the death of the originating agent;
c) a post-death software system which after the death of the originating agent:
i. delivers messages to the selected individual or individuals;
ii. delivers messages when such messages are scheduled or under what conditions the messages are scheduled; and
iii. delivers messages by the means selected.
